(19) United States
(12) Patent Application Publication
(10) Pub. No.: US 2018/0186086 A1
(43) Pub. Date: Jul. 5, 2018

(54) RHINESTONE ART KIT AND METHOD

(71) Applicant: Angela Christine Christy, Redcrest, CA (US)

(72) Inventor: Angela Christine Christy, Redcrest, CA (US)

(21) Appl. No.: 15/397,591

(22) Filed: Jan. 3, 2017

(51) Int. Cl. B29C 65/48; B42D 1/00; B44C 1/18; B42D 15/00

(52) U.S. Cl. CPC B29C 65/48; B42D 1/007; B29L 2031/722; B42D 15/0006; B44C 1/18

(57) ABSTRACT

An art kit and a method for forming a three dimensional rhinestone image from a plurality of rhinestones attached to an object serving as a substrate for the rhinestone image. A rhinestone positioning image formed on the object guides placement of individual rhinestones with a pick and place tool to form the three dimensional rhinestone image. Individual rhinestones may be picked up and placed within a boundary of the rhinestone positioning image by the pick and place tool. Rhinestones are preferably attached to the object by adhesive. An art kit embodiment may include a sheet with a rhinestone positioning image and/or a book having a plurality of pages, at least one page in the book including a rhinestone positioning image.

### FIELD OF THE INVENTION

The present invention relates generally to attachment of a rhinestone or gem to another object, and more specifically to forming a rhinestone image from many individual rhinestones.

### BACKGROUND

Rhinestones, synthetic gemstones, crystals, sequins, and the like may be attached to an object to add light-reflecting highlights to the object. A rhinestone may be manufactured from glass, rock crystal, a polymer material, or another light-reflecting material, and may be made in a variety of colors and shapes. Some rhinestones mimic a shape and/or color of a faceted gemstone. Locations for attachment of rhinestones on an object may be selected at the discretion of the person performing the placement, without guidance or instructions about where rhinestones are to be attached to the object to achieve a desired aesthetic effect.

### SUMMARY

An example embodiment of an art kit for forming a three-dimensional rhinestone image on a surface of an object may include a pick and place tool for holding a rhinestone; a plurality of rhinestones; and a rhinestone positioning image formed on a surface of an object, said rhinestone positioning image a guide for placement of said plurality of rhinestones on said object.

An example of a method embodiment for forming a three-dimensional rhinestone image on an object may include forming a rhinestone positioning image on an object; selecting a rhinestone from among a plurality of rhinestones; picking up the selected rhinestone with a pick and place tool; positioning the selected rhinestone against the object within a boundary of the rhinestone positioning image; attaching the rhinestone to the object; and positioning an additional plurality of rhinestones within the rhinestone positioning image to form a three-dimensional rhinestone image.

Another example of an apparatus embodiment includes a book with a plurality of pages, each of the pages including a rhinestone positioning image for guiding placement of a plurality of rhinestones within a boundary of the rhinestone positioning image; a plurality of rhinestones for attachment to at least one of the pages; and a pick and place tool for picking up the rhinestones.

This section summarizes some features of the present invention. These and other features, aspects, and advantages of the embodiments of the invention will become better understood with regard to the following description and upon reference to the following drawings.

### BRIEF DESCRIPTION OF THE DRAWINGS

FIG. 1 is a view of an example rhinestone image made with an art kit embodiment, showing a three dimensional rhinestone image made from a plurality of rhinestones placed within the boundaries of a rhinestone positioning image.

FIG. 2 shows an example of a rhinestone positioning image having a high-contrast outline.

FIG. 3 is a view toward a top side of a rhinestone in accord with the disclosed examples.

FIG. 4 is a side view of the example of a rhinestone from FIG. 3.

FIG. 5 is a side view of an example of a pick and place tool adapted for picking up a rhinestone and attaching the rhinestone to a rhinestone positioning image.

FIG. 6 shows a view toward the tip of the example of a pick and place tool of FIG. 5.

FIG. 7 shows a side view of the example pick and place tool coupled to an example of rhinestone for lifting and placement of the rhinestone.

FIG. 8 shows the example rhinestone from FIG. 7 attached to a surface on an object serving as a substrate for a three dimensional rhinestone image, and further showing the tip of the example pick and place tool separated from the rhinestone after the rhinestone is attached to the surface of the object.

FIG. 9 shows a view toward a front cover of an example of an art kit comprising a book having a plurality of rhinestone positioning images.

FIG. 10 shows a side view of the example art kit of FIG. 1, further showing an example of an expandable binding.

FIG. 11 shows an example of a page and rhinestone positioning image which may be included with an art kit embodiment.

FIG. 12 shows a view toward an inside surface of the front cover of the art kit example of FIGS. 9-11.

FIG. 13 shows a view toward a front side of an example of a hinged box adapted for decoration with a rhinestone image formed with tools and materials provided in an art kit embodiment.

FIG. 14 is a side view of the example of a hinged box from FIG. 13. In the example of FIG. 14, the top surface of the lid, one of the surfaces upon which a rhinestone image may be formed, is a curved, nonplanar surface.

FIG. 15 is a view toward a top surface of the lid on the example of a hinged box from FIGS. 13-14, further showing an example of a rhinestone positioning image formed on the nonplanar top surface of the lid.

FIG. 16 shows an example of a completed rhinestone image comprising a plurality of rhinestones attached to the nonplanar top surface of the box lid.

### DESCRIPTION

An example apparatus embodiment includes an art kit providing materials and tools for embellishing an object with a three-dimensional rhinestone image. A rhinestone positioning image formed on the object guides placement of individual rhinestones to form the three dimensional rhinestone image. A pick and place tool may be provided to pick up individual rhinestones, place a selected rhinestone within the boundary lines of the rhinestone positioning image, and press the rhinestone against the surface of the object to be decorated until the rhinestone attaches to the object. An embodiment may include steps in a method to form a rhinestone image over a rhinestone positioning image formed on a surface of an object. A rhinestone positioning image may be formed on a planar surface, for example a sheet of paper or other flat stock. A rhinestone positioning image may be formed on a nonplanar surface of an object. In another example art kit embodiment, pages are bound together in a book, with at least one page including a rhinestone positioning image.

An art kit embodiment provides tools and materials for a person to quickly and easily create colorful three-dimensional images by guided placement of many individual rhinestones. Two of the three spatial dimensions of a three dimensional rhinestone image are the length and width of the rhinestone positioning image formed on the object. The third spatial dimension for a rhinestone image corresponds to the distance that the top surfaces of the rhinestones extend outward from the object to which the rhinestones are attached. The rhinestones in a three dimensional rhinestone image may all be a same size and shape, or may alternatively be more than one size and/or more than one shape.

The pick and place tool included with an art kit embodiment permits accurate placement of each rhinestone over the rhinestone positioning image formed on an object serving as a substrate for a three dimensional rhinestone image. The rhinestone positioning image may be formed with clearly visible edge outlines to guide placement of the rhinestones for forming a completed three-dimensional rhinestone image. The rhinestone positioning image may be formed with colors and/or labels representing the colors of rhinestones to be attached to the object.

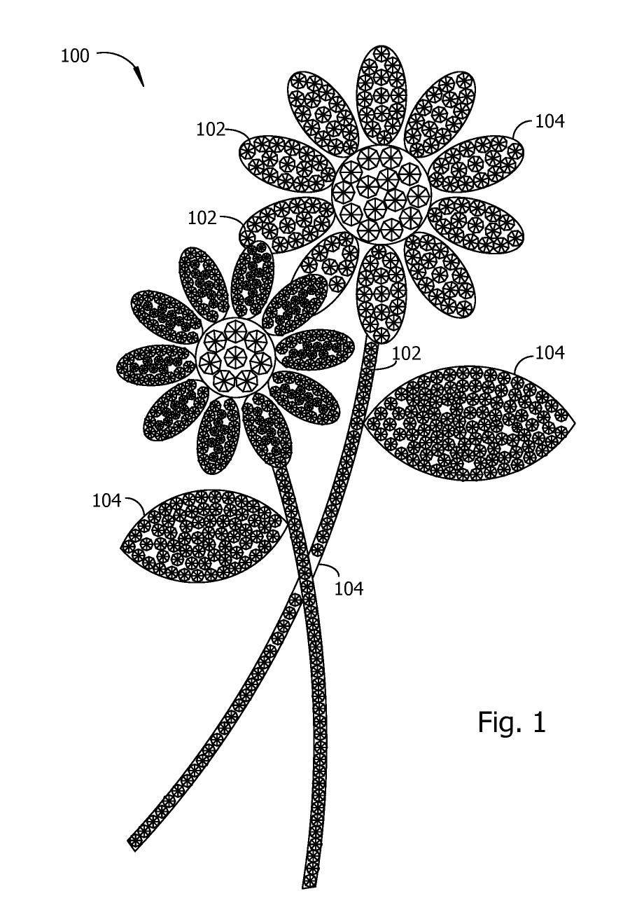

An example of a three dimensional rhinestone image formed in accord with an art kit embodiment is shown in the example of FIG. 1. The example rhinestone image 100 includes a plurality of rhinestones 102 placed on a rhinestone positioning image. In the example of FIG. 1, the rhinestone positioning image is represented by outlines 104. The outlines 104, corresponding to boundaries for the rhinestone positioning image, provide guidance for placement of individual rhinestones to form a three dimensional rhinestone image. Rhinestones 102 are preferably placed on the object serving as the substrate for the rhinestone image within the boundaries corresponding to the outlines 104.

The boundaries of the outlines 104 may be divided into separate areas 104A, 104B, 104C, 104D, where each boundary area may optionally guide a different selection and/or arrangement of rhinestones. Rhinestones 102 of different sizes may be placed on the rhinestone positioning image within the boundaries 104. For example, rhinestones near a center of a flower in FIG. 1 may be larger than rhinestones on flower petals. Furthermore, a color of rhinestones 102 for flower petals may be different than a color of rhinestones for leaves or stems. Rhinestones may optionally be placed in sufficient numbers to completely obscure the underlying rhinestone positioning image and/or outlines. The rhinestone positioning image may be marked with labels indicating where rhinestones of a preferred size, shape, and/or color are to be placed. A color photograph of a completed three dimensional rhinestone image may optionally be provided with an art kit embodiment to give additional guidance on rhinestone selection and placement.

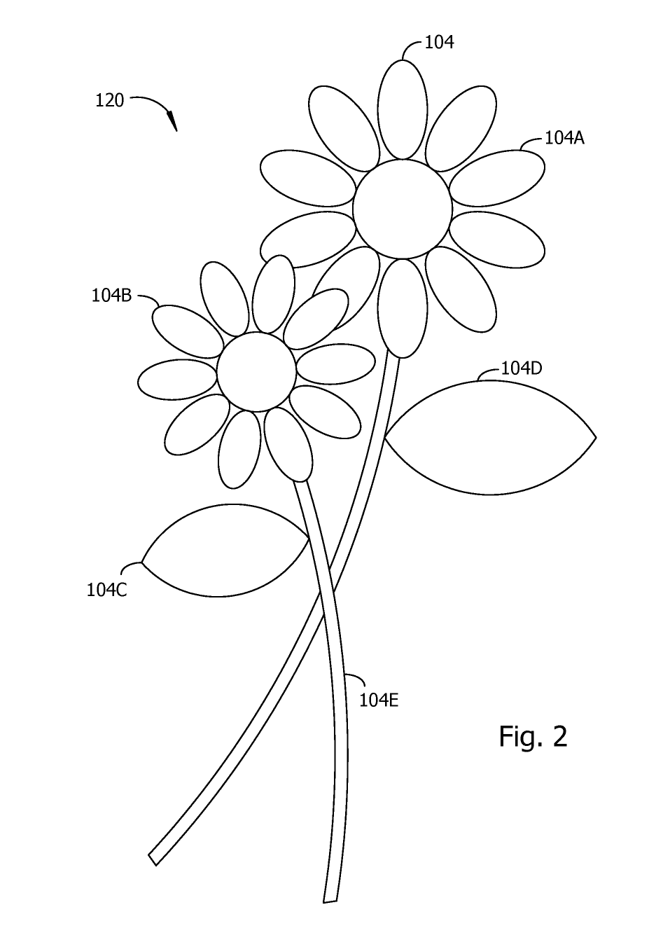

FIG. 2 shows an example of a rhinestone positioning image 120. The rhinestone positioning image 120, represented in the example of FIG. 2 by a high-contrast outline 104 of flowers, is the same as the outline 104 in the example of FIG. 1. Although the examples herein show two flowers as an example of a rhinestone positioning image, it will be appreciated that many other subjects may be represented by a rhinestone positioning image 120 having an outline 104 formed on a surface of an object serving as the substrate for a three dimensional rhinestone image. Examples of rhinestone positioning images include, but not limited to, people, landscape scenes, animals, abstract designs, and so on. Parts of the outline may optionally be marked to receive rhinestones of different colors, for example by coloring part of the outline 104A yellow for yellow rhinestones, another part 104B orange for orange rhinestones, other parts 104C and 104E for green rhinestones, and another part 104D for clear rhinestones.

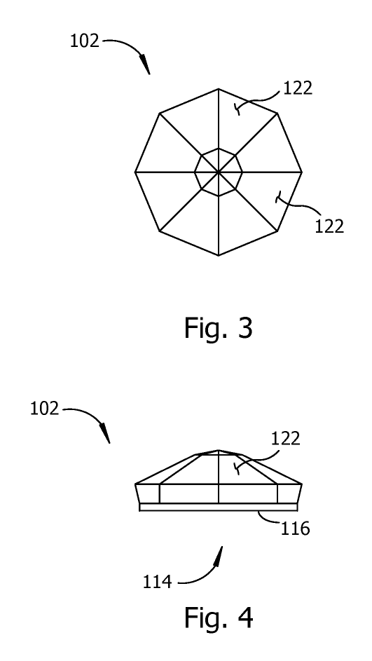

FIGS. 3 and 4 show an example of a rhinestone in accord with an embodiment. The example rhinestone 102 may be formed with a plurality of faceted faces 122 and may be approximately flat on a back surface 114. The example rhinestone 102 may optionally include a layer of adhesive 116 applied to the back surface 114. The adhesive 116 may alternately be omitted from the rhinestone and may instead by applied on the object to be decorated.

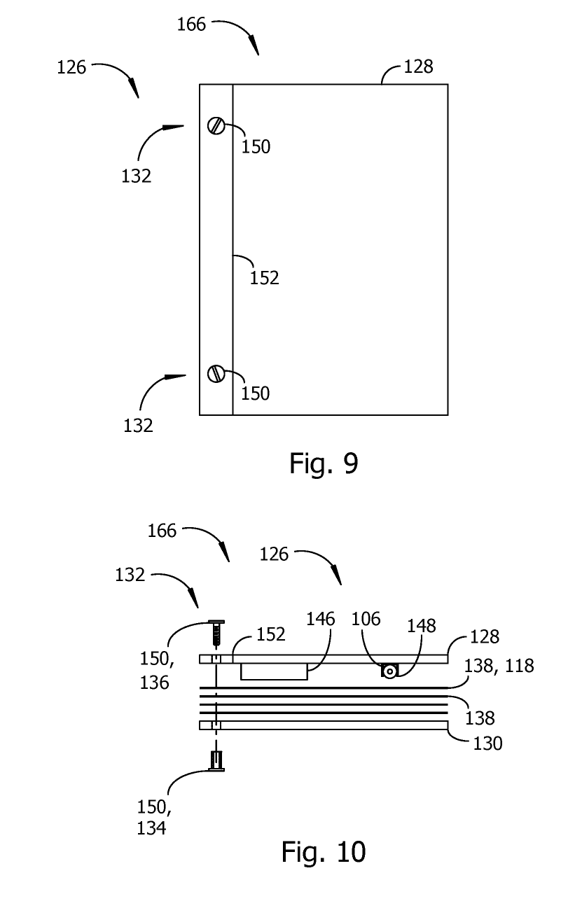

In the example of FIGS. 3-4, the rhinestone has a polygonal shape that mimics a faceted gemstone. Embodiments may optionally use rhinestones of almost any regular or irregular polygonal or curved perimeter shaper. An art kit embodiment, for example the art kit 166 in FIGS. 9, 10, and 12 may include an assortment of different sizes and shapes of rhinestones, a pick and place tool adapted for picking up and placing rhinestones, and an optional object to be decorated with a three-dimensional rhinestone image. The art kit embodiment may optionally include a covered container for storing the assortment of rhinestones.

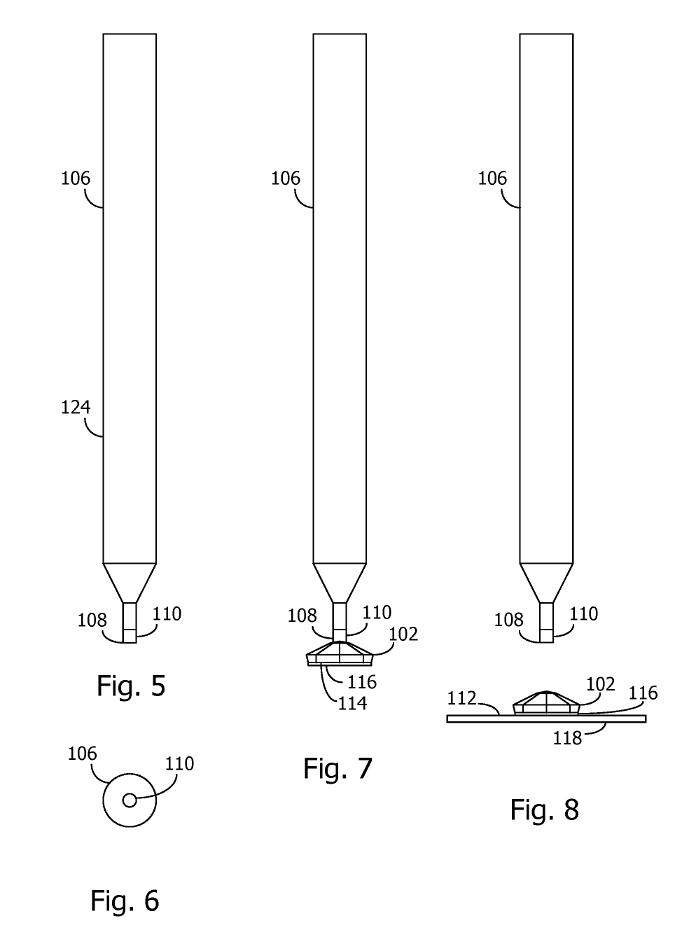

FIGS. 5-7 show side views of an example of a pick and place tool adapted to lift and position rhinestones to form a rhinestone image. FIG. 5 shows a side view of an example elongate pick and place tool 106 having a tool tip 108. The tool tip 108 may be formed from a material that is soft enough to deform around and grip a rhinestone. Alternatively, the tool tip may include a low tack adhesive 110 for gripping a rhinestone. Examples of a low tack adhesive 110 include, but are not limited to, wax, putty, and clay. In an alternative embodiment, a pick and place tool may have a hollow tip that lifts a rhinestone by suction after the tool is squeezed to evacuate air from a cavity inside the tool. FIG. 6 shows a view toward the example tool tip 110 from FIG. 5. FIG. 7 shows an example of a rhinestone 102 coupled to the tool tip 110 strongly enough to permit the rhinestone to be lifted and placed on an object 118 without dropping the rhinestone from the tool tip. Other examples of a pick and place tool 106 include, but are not limited to, a tweezer, a wax pencil, and pliers. An example of a tweezer 106 is shown in FIG. 12.

The example of a pick and place tool 106 is shown in FIG. 8 detached from the rhinestone 102 after the rhinestone has been attached to the substrate. The rhinestone positioning image 104 represented by an outline in previous examples is preferably formed on the attachment surface 112 of the substrate 118. The substrate 118 represents an object to be decorated with a three-dimensional rhinestone image, for example, but not limited to, a page in a book, a book cover, a decorative box, a case for a telephone or computer, a lamp base, a lamp shade, a picture frame, a purse, a backpack, a vase, an article of clothing, and so on, any one or more of which may be included as part of an art kit embodiment.

Examples of materials for an object 118 include, but are not limited to, paper, fabric, metal, polymer material, glass, cardboard, foam-core board, composite materials, and wood. A substrate 118 may be rigid or flexible, porous or nonporous. The adhesive layer 116 may be insoluble in water and other common household solvents and cleaners. The adhesive 116 may be placed on the object 118 instead of on the back surface of the rhinestone. In some embodiments, adhesive is placed on both the rhinestone and the substrate surface.

Examples of a method embodiment include any one or more of the following operations, singly or in any combination:
forming a rhinestone positioning image on an object;
selecting a rhinestone from among a plurality of rhinestones;
picking up the selected rhinestone with a pick and place tool;
positioning the selected rhinestone against the object within a boundary of the rhinestone positioning image;
attaching the rhinestone to the object; and
positioning an additional plurality of rhinestones within the rhinestone positioning image to form a three-dimensional rhinestone image.

The example method embodiment may further include any of the following, singly or in any combination:
pressing a low tack adhesive on a tool tip of the pick and place tool against the selected rhinestone, and lifting the selected rhinestone with the pick and place tool;
matching a color of the selected rhinestone with a color on the rhinestone positioning image;
placing an additional plurality of rhinestones on the object within the boundary of the rhinestone positioning image to form a three dimensional rhinestone image;
attaching the selected rhinestone to the object with an adhesive;
removing the selected rhinestone from the pick and place tool after attaching the selected rhinestone to the object;
applying a plurality of rhinestones having more than one size;
applying a plurality of rhinestones having more than one shape;
applying an adhesive to the object before placing the selected rhinestone against the object;
applying an adhesive to the selected rhinestone before placing the selected rhinestone against the object;
placing an additional plurality of rhinestones on the object to cover a selected area of the rhinestone positioning image, for example a selected area represented in the example of FIG. 1 by a flower petal (104A, 104B), a leaf (104C, 104D), or a stem 104E;
applying a plurality of rhinestones having more than one size; and
applying a plurality of rhinestones having more than one shape.

In another example embodiment of an art kit, materials for forming rhinestone images are collected together in a book as suggested in the examples of FIGS. 9-12. FIG. 9 shows a view toward a front cover 128 of an example of a book 126. The front cover may optionally be made from a stiff material and may be formed with a bend line 152 to permit the cover to be folded back toward the binding 132. The binding 132 may optionally be an expandable binding. A plurality of pages 138 may be captured between the front cover 128 and a back cover 130 as suggested in the example of FIG. 10. The expandable binding 132 may include a binding fastener 150 that passes through apertures formed in the covers and individual pages.

In some embodiments, the binding fastener 150 includes a bolt 136 that threadably engages a nut 134, for example a barrel nut 134 that passes through apertures in the back cover or front cover. The barrel nut may further pass through apertures in one or more of the pages. Either one or both of the barrel nut 134 and threaded bolt 136 may have a head adapted for engagement with a screwdriver or alien wrench. Other examples of a binding fastener include, but are not limited to, a hinged split ring for a loose-leaf binder, a coil binding, a comb binding, stitching, a staple, a rivet, and adhesive.

In the end view of the book embodiment example of FIG. 10, the covers (128, 130), pages 118, and expandable binding (132, 134, 150) have been separated from one another to show how pages 138 may be added to or removed from the book. In some embodiments of an art kit and/or book 126, an optional covered container 146 may be included, possibly by attachment to a cover of the book or as a separate item not attached to the book. The covered container 146 may hold an assortment of rhinestones for attachment to the pages in the book. A page 138 may correspond to the substrate 118 upon which a three dimensional rhinestone image may be formed. A retaining clip 148 for storing a pick and place tool 106 may be attached to the cover 128 or to another part of the book. The pick and place tool 106 may be included with the book embodiment 126. In other book embodiments, the container 146 may be attached to the back cover. In some embodiments, the front cover and back cover are connected directly to one another, forming one continuous cover.

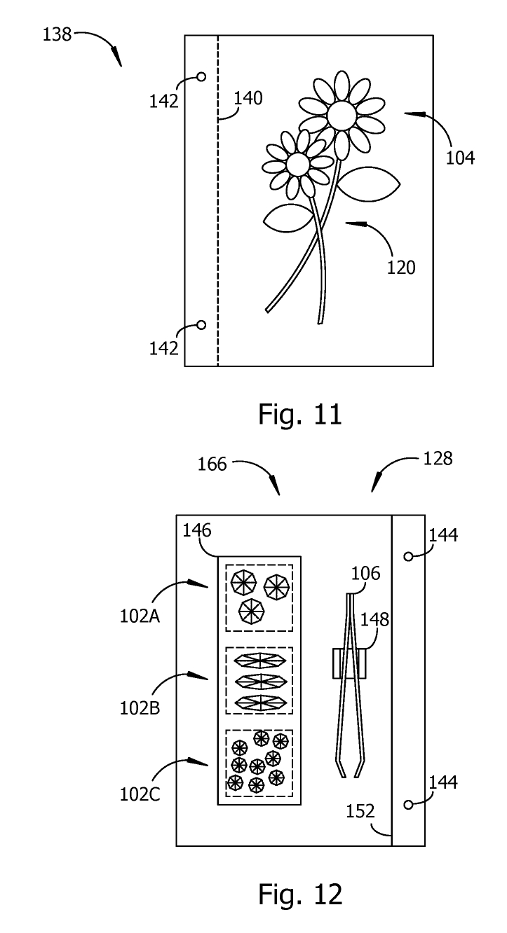

FIG. 11 shows an example of a page 138 with a rhinestone positioning image 120. For pages to be included with a book 126 as in the example of FIG. 10, each page 138 may be formed with one or more apertures 142 through which binding fasteners may be passed to secure the covers and pages to one another in an expandable binding. Each page may be formed with a perforation 140 to permit the part of a page with a rhinestone positioning image 120 to be detached from the book.

FIG. 12 shows a view toward a surface of a cover, for example a front cover 128 or a back cover. In the example of FIG. 12, the view is toward a surface of the front cover that will face a page in the book when the book is closed. Both covers may be formed with apertures 144 through which binding fasteners may be passed. The container 146 for holding rhinestones 102 and the retaining clip 148 for holding the pick and place tool 106 may be attached to the cover 128. The container 146 may hold rhinestones 102 of different sizes 102A, shapes 102B, and colors 102C.

FIG. 12 further illustrates an example of an art kit 166 for embellishing an object other than pages in a book. One or more pages 138 as in the example of FIG. 11 may be included with an art kit 166. The pages 138 may be supplied as loose sheets or may be bound together in book form. Other parts of the art kit 166 in the example of FIG. 12 include, but are not limited to, an assortment of rhinestones of different colors and sizes (102A, 102B, 102C), possibly stored in a covered container 146, a pick and place tool 106, for examples tweezers as shown in FIG. 12 or an elongate tool as suggested in FIGS. 5-8, and possibly a storage clip 148 for the pick and place tool 106.

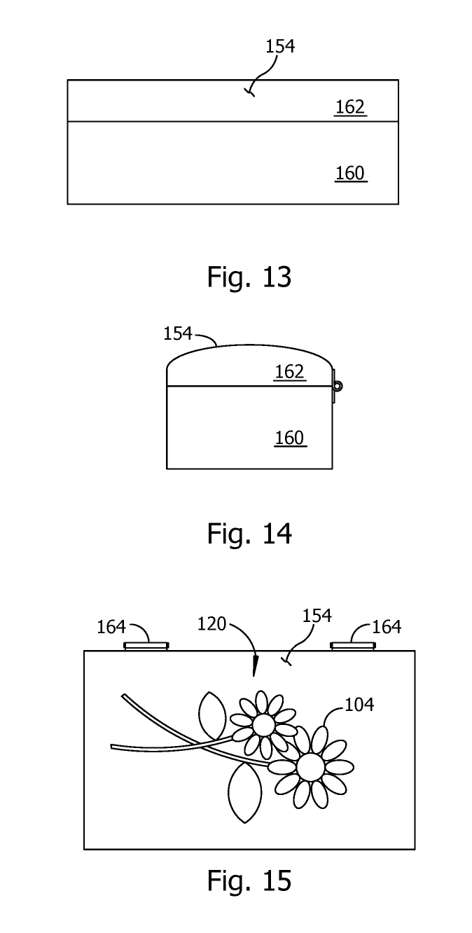

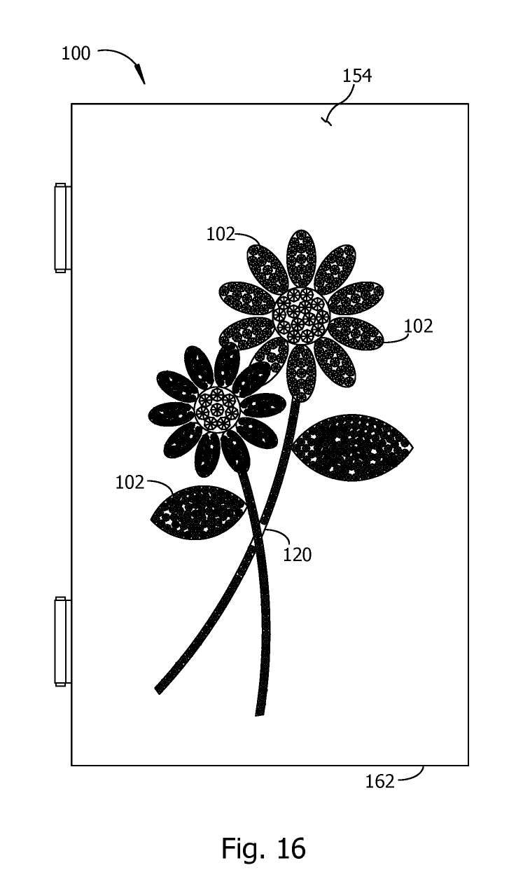

FIGS. 13-16 show examples of an object which may be embellished with a three dimensional rhinestone image using an art kit embodiment. An art kit embodiment 100 may include the object to be embellished. In the example of FIGS. 13-16, the example object is a box 160 having a lid 162. The lid 162 may optionally be coupled to the box 160 by hinges 164. As suggested in FIG. 14 and FIG. 15, the rhinestone positioning image 120 may be formed on a nonplanar surface 154 of the object, although the rhinestone image may be formed on any planar surface if desired. Rhinestones 102 may be positioned within the boundaries of the rhinestone positioning image 120 as suggested in FIG. 16 to form a three-dimensional rhinestone image 100.

Unless expressly stated otherwise herein, ordinary terms have their corresponding ordinary meanings within the respective contexts of their presentations, and ordinary terms of art have their corresponding regular meanings.

What is claimed is:

1. An art kit for forming a three-dimensional rhinestone image, comprising:
a pick and place tool for holding a rhinestone;
a plurality of rhinestones; and
a rhinestone positioning image formed on a surface of an object, said rhinestone positioning image a guide for placement of said plurality of rhinestones on said object.

2. The apparatus of claim 1, wherein said rhinestone positioning image comprises separate boundary areas to guide placement of said plurality of rhinestones on said rhinestone positioning image.

3. The apparatus of claim 1, wherein said rhinestone positioning image is formed with colors corresponding to preferred colors of said plurality of rhinestones to be attached to said object.

4. The apparatus of claim 1, wherein said pick and place tool includes a low-tack adhesive applied to a tool tip.

5. The apparatus of claim 1, wherein said pick and place tool is a wax pencil.

6. The apparatus of claim 1, wherein said pick and place tool is a tweezer.

7. A method, comprising:
forming a rhinestone positioning image on an object;
selecting a rhinestone from among a plurality of rhinestones;
picking up the selected rhinestone with a pick and place tool;
positioning the selected rhinestone against the object within a boundary of the rhinestone positioning image;
attaching the rhinestone to the object; and
positioning an additional plurality of rhinestones within the rhinestone positioning image to form a three-dimensional rhinestone image.

8. The method of claim 7, further comprising pressing a low tack adhesive on a tool tip of the pick and place tool against the selected rhinestone, and lifting the selected rhinestone with the pick and place tool.

9. The method of claim 7, further comprising matching a color of the selected rhinestone with a color on the rhinestone positioning image.

10. The method of claim 7, further comprising placing an additional plurality of rhinestones on the object within the boundary of the rhinestone positioning image to form a three dimensional rhinestone image.

11. The method of claim 7, further comprising attaching the selected rhinestone to the object with an adhesive.

12. The method of claim 7, further comprising removing the selected rhinestone from the pick and place tool after attaching the selected rhinestone to the object.

13. The method of claim 7, further comprising applying a plurality of rhinestones having more than one size.

14. The method of claim 7, further comprising applying a plurality of rhinestones having more than one shape.

15. The method of claim 7, further comprising applying an adhesive to the object before placing the selected rhinestone against the object.

16. The method of claim 7, further comprising applying an adhesive to the selected rhinestone before placing the selected rhinestone against the object.

17. An apparatus, comprising:
a book comprising a plurality of pages, at least one of said plurality of pages comprising a rhinestone positioning image for guiding placement of a plurality of rhinestones within a boundary of said rhinestone positioning image;
a plurality of rhinestones for attachment to said pages; and
a pick and place tool for picking up a selected one of said rhinestones and positioning said selected rhinestone within said rhinestone positioning image.

18. The apparatus of claim 17, further comprising a container for holding said plurality of rhinestones.

19. The apparatus of claim 17, wherein each of said plurality of pages is formed with a perforation for separating said pages from said book.

20. The apparatus of claim 17, wherein said book comprises an expandable binding.
